(19) United States
(12) Patent Application Publication
(10) Pub. No.: US 2019/0228468 A1
(43) Pub. Date: Jul. 25, 2019

(54) REGULATORY INSPECTION IN A BLOCKCHAIN NETWORK

(71) Applicant: Alibaba Group Holding Limited, George Town (KY)

(72) Inventors: Danqing Hu, Hangzhou (CN); Sen Lin, Shanghai (CN)

(73) Assignee: Alibaba Group Holding Limited, George Town (KY)

(21) Appl. No.: 16/252,077

(22) Filed: Jan. 18, 2019

(30) Foreign Application Priority Data
Jan. 19, 2018 (CN) 201810055525.3

(51) Int. Cl. G06Q 40/02; H04L 9/06; G06Q 20/02

(52) U.S. Cl. CPC G06Q 40/02; H04L 9/0618; H04L 2209/56; H04L 2209/38; G06Q 20/02

(57) ABSTRACT

Implementations of the present specification provide a method, an apparatus, and an electronic device for regulatory inspection that can be applied to a remittance system based on a blockchain technology. The method includes: retrieving, by a supervising node in a blockchain network, a remittance link associated with a remittance to be inspected from a blockchain maintained by the blockchain network; retrieving, by the supervising node from the blockchain, a first inspection result of a compliance inspection performed by a node in the remittance link on an inspection document that corresponds to the remittance to be inspected; performing, by the supervising node, a compliance inspection on the inspection document to obtain a second inspection result; and determining, by the supervising node, that the compliance inspection is abnormal based on a comparison of the second inspection result and the first inspection result.

### CROSS-REFERENCE TO RELATED APPLICATIONS

This application claims priority to Chinese Patent Application No. 201810055525.3, filed on Jan. 19, 2018, which is hereby incorporated by reference in its entirety.

### TECHNICAL FIELD

Implementations of the present specification relate to the field of blockchain technologies, and in particular, to a method, an apparatus, and an electronic device for regulatory inspection.

### BACKGROUND

A supervisor is a party to supervise whether there are problems with each bank in a remittance system. For example, the supervisor needs to supervise a bank compliance inspection. The compliance inspection here means that a bank inspects whether a remittance initiated by a remitter is abnormal. Usually, funds may need to pass through one or more banks from the remitter to a remittee. For example, the funds of the remitter go to the remittee through a plurality of banks. The funds first are transferred from the remitter to bank A, then are transferred from bank A to bank B, and eventually are transferred from bank B to the remittee. Usually, the previous path can be referred to as a remittance link. The remittance is terminated if an inspection result of a compliance inspection on at least one bank in the remittance link is failed. The remittance can be formally executed only when inspection results of compliance inspections on all banks in the remittance link are succeeded. Results of compliance inspections on the same remitter can be different because compliance inspection standards are usually formulated by the banks themselves. Even if only one bank's compliance inspection standard has problems, the remittance link can be interrupted consequently. The supervisor needs to supervise the bank compliance inspection to identify a problem in the bank compliance inspection in time. The existing remittance system does not provide bank compliance inspection data. The supervisor usually requires the banks to provide their own inspection results, but the supervisor cannot ensure that the inspection results provided by the banks are true.

### SUMMARY

Implementations of the present specification provide a method, an apparatus, and an electronic device for regulatory inspection.

According to a first aspect of the implementations of the present specification, a regulatory inspection method is provided, and is applied to a remittance system based on a blockchain technology, where the method includes the following: obtaining, by a supervising member, a remittance link involved in a remittance to be inspected from a blockchain, where the remittance link corresponds to members of the remittance to be inspected; obtaining, by the supervising member from the blockchain, a first inspection result of a compliance inspection performed by at least one member in the remittance link on an inspection document that corresponds to the remittance to be inspected; performing, by the supervising member, a compliance inspection on the inspection document to obtain a second inspection result; and determining, by the supervising member, a member whose compliance inspection is abnormal based on the second inspection result and the first inspection result.

According to a second aspect of the implementations of the present specification, a regulatory inspection method is provided, and is applied to a remittance system based on a blockchain technology, where the method includes the following: obtaining, by a supervising member, a remittance link involved in a remittance to be inspected from a blockchain, where the remittance link corresponds to members of the remittance to be inspected; obtaining, by the supervising member from the blockchain, inspection results of compliance inspections performed by at least three members in the remittance link on an inspection document that corresponds to the remittance to be inspected; comparing the inspection results of the compliance inspections performed by the members on the inspection document; and determining a member whose compliance inspection is abnormal based on the comparison result.

According to a third aspect of the implementations of the present specification, a regulatory inspection apparatus is provided, and is applied to a remittance system based on a blockchain technology, where the apparatus includes the following: a first acquisition unit, configured to obtain, by a supervising member, a remittance link involved in a remittance to be inspected from a blockchain, where the remittance link corresponds to members of the remittance to be inspected; a second acquisition unit, configured to obtain, by the supervising member from the blockchain, a first inspection result of a compliance inspection performed by at least one member in the remittance link on an inspection document that corresponds to the remittance to be inspected; an inspection unit, configured to perform, by the supervising member, a compliance inspection on the inspection document to obtain a second inspection result; and a verification unit, configured to determine, by the supervising member, a member whose compliance inspection is abnormal based on the second inspection result and the first inspection result.

According to a fourth aspect of the implementations of the present specification, a regulatory inspection apparatus is provided, and is applied to a remittance system based on a blockchain technology, where the apparatus includes the following: a first acquisition unit, configured to obtain, by a supervising member, a remittance link involved in a remittance to be inspected from a blockchain, where the remittance link corresponds to members of the remittance to be inspected; a second acquisition unit, configured to obtain, by the supervising member from the blockchain, inspection results of compliance inspections performed by at least three members in the remittance link on an inspection document that corresponds to the remittance to be inspected; a comparison unit, configured to compare the inspection results of the compliance inspections performed by the members on the inspection document; and a verification unit, configured to determine a member whose compliance inspection is abnormal based on a comparison result.

According to a fifth aspect of the implementations of the present specification, an electronic device is provided, including the following: a processor; and a memory configured to store an executable instruction of the processor, where the processor is configured to implement the regulatory inspection method according to any one of the previous implementations.

The present specification provides a regulatory inspection solution to construct a remittance system that includes supervision by using the blockchain technology. Using the tamper-resistance feature of the blockchain, the inspection results of the compliance inspections performed by the members involved in the remittance can be recorded in the blockchain truly. As such, the compliance inspection results provided by the members are directly obtained from the blockchain by the supervising members, and are certainly true inspection results of the members, and then the supervising member can verify the obtained inspection results to learn which members' compliance inspections are abnormal.

### BRIEF DESCRIPTION OF DRAWINGS

FIG. 1 is a concept diagram illustrating a system architecture for implementing regulatory inspection, according to an implementation of the present specification;

FIG. 2 is a flowchart illustrating a regulatory inspection method, according to an implementation of the present specification;

FIG. 3 is a schematic diagram illustrating a remittance link, according to an implementation of the present specification;

FIG. 4 is a flowchart illustrating a regulatory inspection method, according to an implementation of the present specification;

FIG. 5 is a schematic diagram illustrating modules of a regulatory inspection apparatus, according to an implementation of the present specification;

FIG. 6 is a schematic diagram illustrating modules of a regulatory inspection apparatus, according to an implementation of the present specification; and

FIG. 7 is a flowchart illustrating an example of a computer-implemented method for regulatory inspection, according to an implementation of the present disclosure.

### DESCRIPTION OF IMPLEMENTATIONS

Implementations are described in detail here, and examples of the implementations are presented in the accompanying drawings. When the following description relates to the accompanying drawings, the same numbers in different accompanying drawings represent the same or similar elements unless specified otherwise. Implementations described in the following do not represent all implementations consistent with the present specification. On the contrary, the implementations are only examples of apparatuses and methods that are described in the appended claims in detail and consistent with some aspects of the present specification.

The terms used in the present specification are merely for illustrating specific implementations, and are not intended to limit the present specification. The terms “a”, “said”, and “the” of singular forms used in the present specification and the appended claims are also intended to include plural forms, unless otherwise specified in the context clearly. It should also be understood that, the term “and/or” used in the present specification indicates and includes any or all possible combinations of one or more associated listed items.

It should be understood that although the terms “first”, “second”, “third”, etc. can be used in the present specification to describe various types of information, the information is not limited to the terms. The terms are only used to differentiate information of the same type. For example, without departing from the scope of the present specification, first information can also be referred to as second information, and similarly, the second information can also be referred to as the first information. Depending on the context, for example, the word “if” used here can be explained as “while”, “when”, or “in response to determining”.

A blockchain technology is an emerging technology that several computing devices jointly participate in “transaction recording” to jointly maintain a complete distributed database. The blockchain technology has the following features: decentralization, openness and transparency, each computing device can participate in the database record, and data synchronization can be quickly performed between computing devices. Therefore, using the blockchain technology to construct a decentralized system and recording various execution programs in a blockchain distributed database for automatic execution have been widely applied to many fields. For example, in the field of financial technologies, the blockchain technology can be used to construct a remittance system to implement fast fund transfer. Especially in a cross-border remittance scenario, the blockchain technology can be used to construct a remittance system, so that a plurality of parties has less trust to each other can participate in the coordination of banks among institutions such as different countries or regions to reduce remittance waiting time and improve the remittance efficiency. Because remittance records are stored in a blockchain ledger by using a tamper-resistance method, it can be ensured that the whole link in the entire remittance process is transparent and reliable.

In the remittance system provided in the present specification, a blockchain can store several members (Member) in a remittance link, and information about other members outside the remittance link. The members can be nodes in the blockchain.

In an implementation, the member in the remittance link can be a financial institution that supports a remittance service, or organizations or platforms in other forms. Implementations are not limited in the present specification. The financial institution is used as an example, and the members in the remittance link can belong to different institutions (for example, a plurality of banks), or can belong to different branches of the same institution (for example, a plurality of branches of the same bank). Implementations are not limited in the present specification.

The blockchain uses a form of distributed ledger technology, each node stores full-amount transaction recording information, and the nodes in the blockchain can reach a consensus by using a consensus algorithm, to jointly maintain a unified ledger, namely, a blockchain ledger. Therefore, as described in the present specification, when a member reads or records implementation information of the “blockchain ledger”, the member can read or record implementation information of full-amount transaction recording information stored by the member.

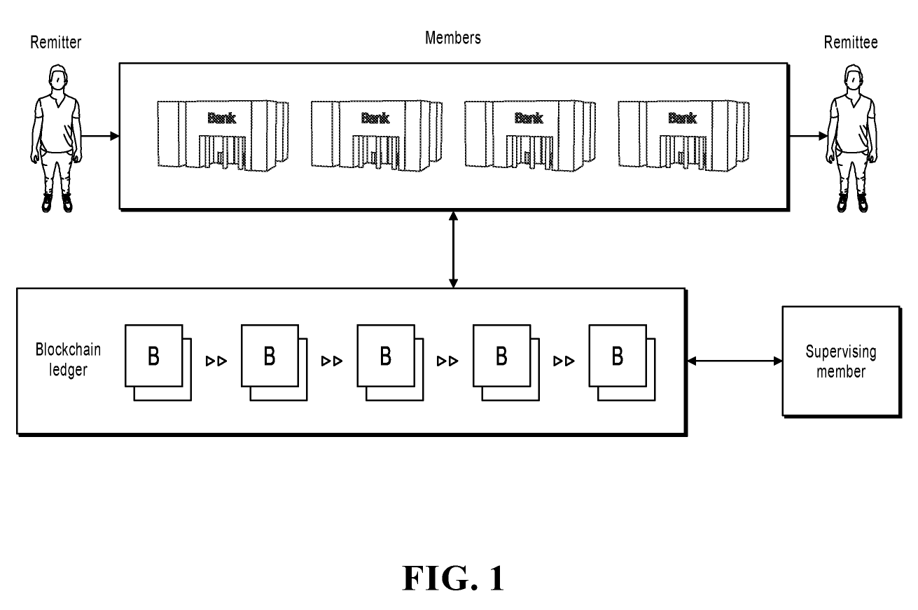

Referring to FIG. 1, FIG. 1 is a concept diagram illustrating an example of a remittance system architecture that can be applied in the present specification. The concept diagram of the remittance system architecture can include a remitter, a remittee, a member, a blockchain ledger, and a supervising member. In an implementation, the remitter and the remittee can be a person or an organization (such as an enterprise or a platform). Implementations are not limited in the present specification. The remitter initiates a request for making a remittance to the remittee, and the blockchain ledger is routing according to the remitter and the remittee, to determine a remittance link from the remitter to the remittee that passes through several members. Each member in the remittance link needs to perform a compliance inspection on this remittance operation of the remitter. The compliance inspection is mainly used to identify whether a document to be inspected that is provided by the remitter is abnormal. Usually, the compliance inspection can include a Know Your Customer (KYC) inspection and/or an anti-money laundering (AML) inspection. The remittance is terminated when an inspection result of at least one member in the remittance link is failed, and the compliance inspection is re-performed after the remitter provides a more detailed document to be inspected. The remittance can be formally executed only when inspection results of compliance inspections on all banks in the remittance link are succeeded. The blockchain ledger can record an inspection result of a compliance inspection of each member. Because the blockchain has a feature of tamper-resistance, once the blockchain ledger records the inspection result of each member, the inspection result cannot be modified any more, which ensures the authenticity of the inspection result. The supervising member, as a special node in the blockchain, has the capability to supervise the blockchain ledger, for example, to query remittance information or inspect whether a compliance inspection of a member is abnormal.

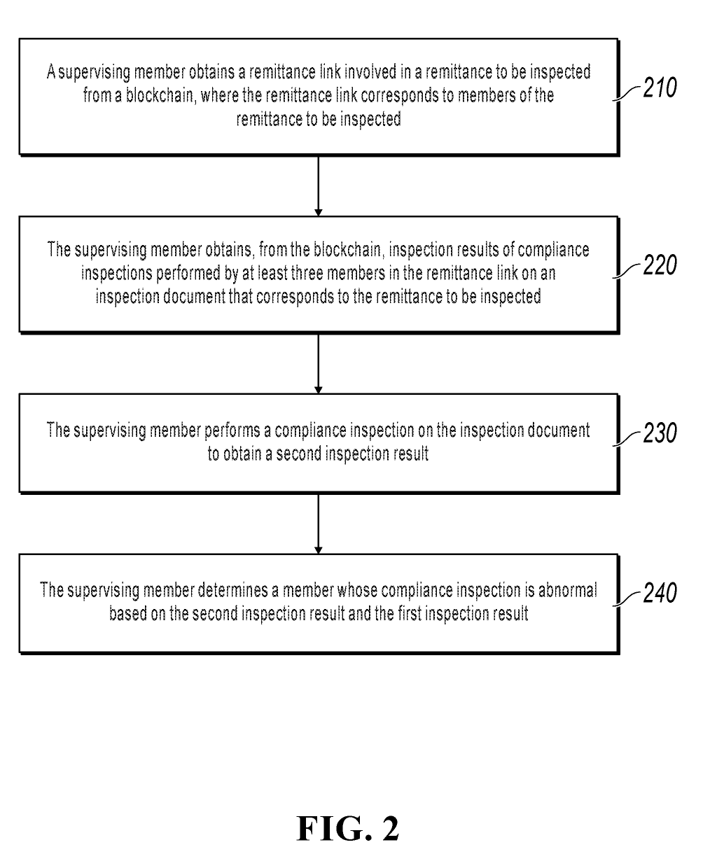

An implementation of a regulatory inspection method in the present specification can be described below with reference to the example shown in FIG. 2. The method is applied to a remittance system based on a blockchain technology. As shown in FIG. 2, the method can include the following steps.

Step 210: A supervising member obtains a remittance link involved in a remittance to be inspected from a blockchain, where the remittance link corresponds to members of the remittance to be inspected.

As described above, the blockchain can record a remitter, a remittee, and members involved in a remittance process that remittance funds pass through from the remitter to the remittee.

In an implementation, before step 210, the method further includes the following: the supervising member receives a remittance inspection request initiated by at least one member in the blockchain.

A member in the blockchain can actively initiate a remittance inspection request to trigger the supervising member to obtain a remittance link involved in a remittance to be inspected from the blockchain. The remittance link corresponds to members of the remittance to be inspected.

In an implementation, before step 210, the method further includes the following: the supervising member determines a completed remittance in the blockchain as the remittance to be inspected when registering the completed remittance in a blockchain ledger.

As described above, any one of the members in the blockchain needs to broadcast the remittance information to all members in the blockchain after recording remittance information. When all the members in the blockchain reach a consensus by using a consensus algorithm, the members can record the broadcast remittance information in the local blockchain ledger. Therefore, when the supervising member registers the completed remittance in the blockchain in the blockchain ledger, it indicates that the remittance has been successfully completed and can be inspected.

In an implementation, the remittance can include a cross-border remittance.

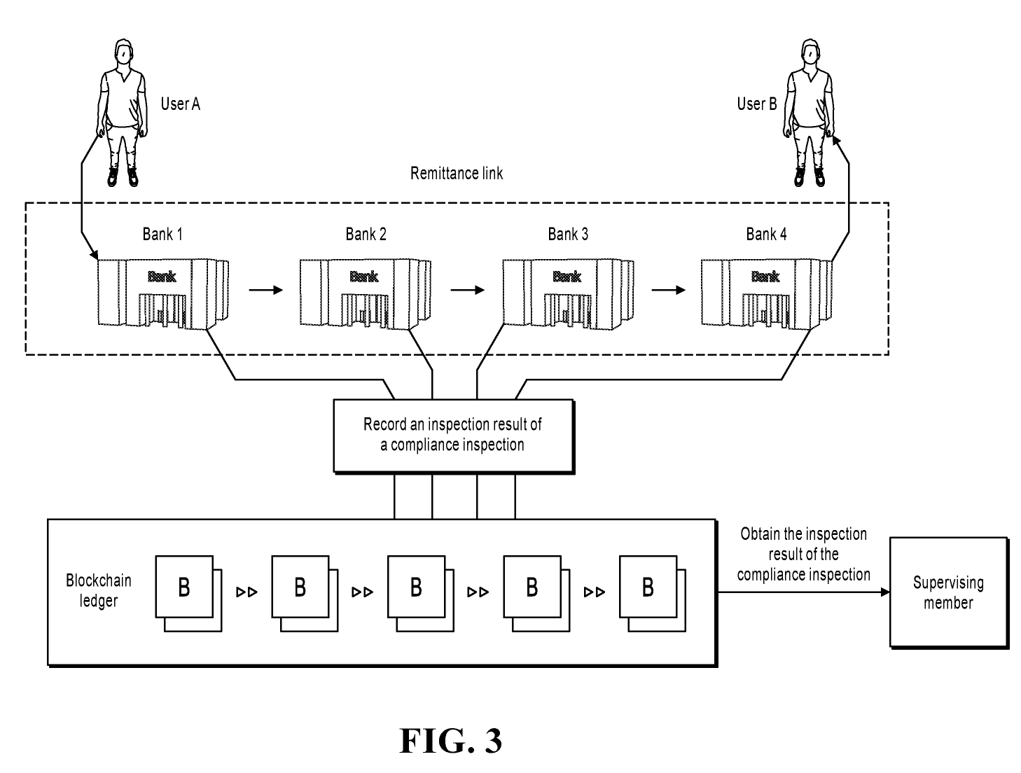

As shown in FIG. 3, FIG. 3 is a schematic diagram illustrating a remittance link involved in a remittance provided in the present specification. The remittance is a remittance made by user A to user B. In other words, the remitter is user A, and the remittee is user B. In addition, the remittance needs to pass through bank 1, bank 2, bank 3, and bank 4. In other words, members involved in the remittance include bank 1, bank 2, bank 3, and bank 4. The entire remittance process can be as follows: User A transfers a remittance amount from an account in bank 1 to a fund balance of bank 2, then transfers the remittance amount from the fund balance of bank 2 to a fund balance of bank 3, then transfers the remittance amount from the fund balance of bank 3 to a fund balance of bank 4, and finally transfers the remittance amount from the fund balance of bank 4 to an account of user B in bank 4.

Step 220: The supervising member obtains, from the blockchain, a first inspection result of a compliance inspection performed by at least one member in the remittance link on an inspection document that corresponds to the remittance to be inspected.

In an implementation, the compliance inspection can include at least one of a KYC inspection, an anti-money laundering inspection, etc. Implementations are not limited in the present specification.

In an implementation, because the blockchain uses a form of distributed ledger technology and each member stores full-amount transaction recording information, the supervising member can obtain, from the blockchain, the first inspection result of the compliance inspection performed by the at least one member in the remittance link on the inspection document that corresponds to the remittance to be inspected.

In an implementation, the at least one member is a member that is registered in the blockchain and that the supervising member has a jurisdiction over. In actual applications, there may be a plurality of different supervising members in the remittance system, and members that different supervising members manage can also be different. In an example of a cross-border remittance, a national supervising member usually can supervise only national members and cannot supervise members in other countries. Therefore, in the blockchain, a mapping relationship between a supervising member and a member that the supervising member has a jurisdiction over can be registered in advance. As such, the supervising member obtains, from the blockchain, the first inspection result of the compliance inspection performed by the at least one member that the supervising member has a jurisdiction over in the remittance link on the inspection document that corresponds to the remittance to be inspected;

In an implementation, step 220 can include the following: the supervising member initiates a contract operation to the blockchain, where the contract operation is used to obtain, from the blockchain, the first inspection result of the compliance inspection performed by the at least one member in the remittance link on the inspection document that corresponds to the remittance to be inspected.

After joining a smart contract, the member in the blockchain can invoke several contract operations supported by the smart contract, for example, the contract operation “used to obtain, from the blockchain, the first inspection result of the compliance inspection performed by the at least one member in the remittance link on the inspection document that corresponds to the remittance to be inspected”. A supervising node initiates a contract operation to the blockchain; and after the contract operation is implemented, can obtain the first inspection result of the compliance inspection performed by the at least one member in the remittance link on the inspection document that corresponds to the remittance to be inspected.

Similarly, the mapping relationship between a supervising member and a member that the supervising member has a jurisdiction over can be registered in advance in the smart contract in the blockchain. As such, the contract operation can be used to obtain, from the blockchain, the first inspection result of the compliance inspection performed by the at least one member that the supervising member has a jurisdiction over in the remittance link on the inspection document that corresponds to the remittance to be inspected.

Step 230: The supervising member performs a compliance inspection on the inspection document to obtain a second inspection result.

In an implementation, the supervising member can perform the compliance inspection on the inspection document to obtain the second inspection result.

In another implementation, the supervising member can push the inspection document to a third-party compliance inspection institution, so that the third-party compliance inspection institution implements a compliance inspection; and obtain the second inspection result returned by the third-party compliance inspection institution.

Step 240: The supervising member determines a member whose compliance inspection is abnormal based on the second inspection result and the first inspection result.

The supervising member uses the second inspection result as a correct result to verify whether the obtained first inspection result of the at least one member is correct.

In an implementation, the supervising member compares the second inspection result with a first inspection result of each member, and determines a member whose first inspection result is different from the second inspection result as the member whose compliance inspection is abnormal.

The present specification provides a regulatory inspection solution to construct a remittance system that includes supervision by using the blockchain technology. Using the tamper-resistance feature of the blockchain, the inspection results of the compliance inspections performed by the members involved in the remittance can be recorded in the blockchain truly. As such, the compliance inspection results provided by the members are directly obtained from the blockchain by the supervising members, and are certainly true inspection results of the members, and then the supervising member can verify the obtained inspection results to learn which members' compliance inspections are abnormal.

In addition, using the global feature of the blockchain, the blockchain can register inspection results of compliance inspections performed by all the members involved in the remittance, so that the supervising member can obtain inspection results of compliance inspections performed by a plurality of members from the blockchain, thereby improving the inspection efficiency of the supervising member.

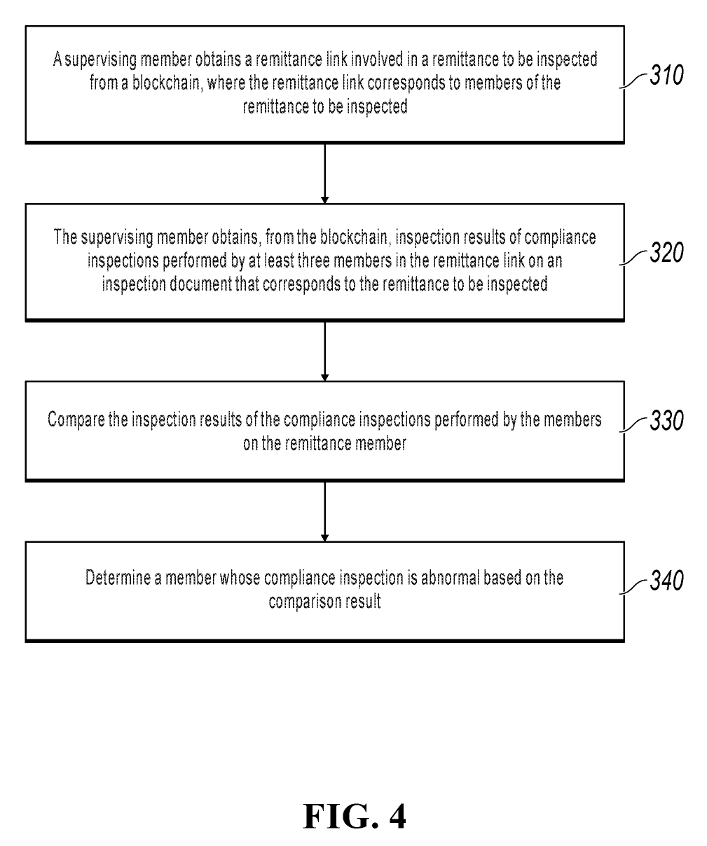

An implementation of a regulatory inspection method in the present specification can be described below with reference to the example shown in FIG. 4. The method is applied to a remittance system based on a blockchain technology. As shown in FIG. 4, the method can include the following steps.

Step 310: A supervising member obtains a remittance link involved in a remittance to be inspected from a blockchain, where the remittance link corresponds to members of the remittance to be inspected.

The step is the same as step 210 in the previous implementation, and details are omitted here for simplicity.

Step 320: The supervising member obtains, from the blockchain, inspection results of compliance inspections performed by at least three members in the remittance link on an inspection document that corresponds to the remittance to be inspected.

In an implementation, step 320 can include the following: the supervising member initiates a contract operation to the blockchain, where the contract operation is used to obtain, from the blockchain, the inspection results of the compliance inspections performed by the at least three members in the remittance link on the inspection document that corresponds to the remittance to be inspected.

The step is the same as step 220 in the previous implementation, and details are omitted here for simplicity.

Step 330: Compare the inspection results of the compliance inspections performed by the members on the inspection document.

Step 340: Determine a member whose compliance inspection is abnormal based on a comparison result.

In an implementation, the member whose compliance inspection is abnormal is a minority of members whose inspection results are different from inspection results of a majority of members. The majority can include half or more than half

In the present implementation, after obtaining the inspection results of the compliance inspections performed by the at least three members in the remittance link on the inspection document that corresponds to the remittance to be inspected, the supervising member can horizontally compare the inspection results, and determines a minority of members whose inspection results are different from inspection results of a majority of members as members whose compliance inspections are abnormal.

Corresponding to the previous implementation of the regulatory inspection method, the present specification further provides an implementation of a regulatory inspection apparatus. The apparatus implementation can be implemented by software, hardware, or a combination of hardware and software. Software implementation is used as an example. As a logical apparatus, the apparatus is formed by reading a corresponding computer program instruction in a non-volatile memory to a memory by a processor of a device where the apparatus is located. In terms of hardware, a hardware structure of a device where the apparatus for regulatory inspection in the present specification is located can include a processor, a network interface, a memory, and a non-volatile memory, and the device where the apparatus in the present implementation is located usually can further include other hardware based on the actual regulatory inspection function. Details are omitted here for simplicity.

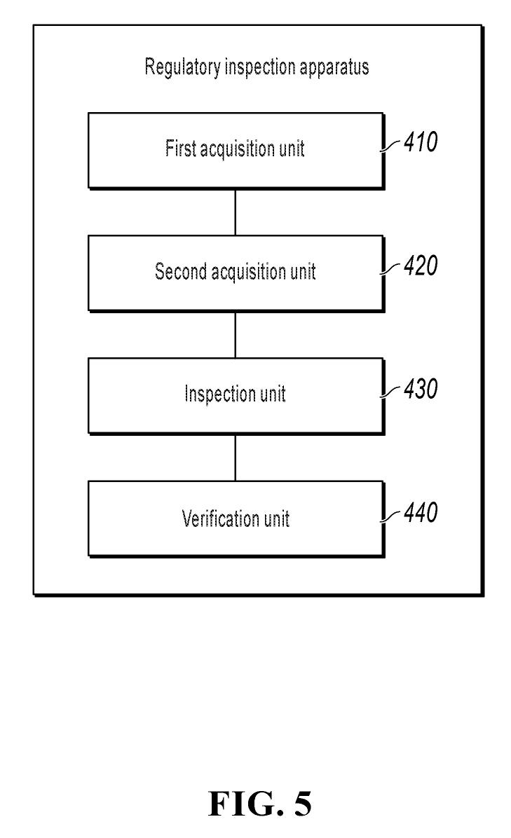

Referring to FIG. 5, FIG. 5 is a diagram illustrating modules of a regulatory inspection apparatus, according to an implementation of the present specification. The apparatus for regulatory inspection can be applied to a remittance system based on a blockchain technology, the apparatus corresponds to the implementation shown in FIG. 2, and the apparatus includes the following: a first acquisition unit 410, configured to obtain, by a supervising member, a remittance link involved in a remittance to be inspected from a blockchain, where the remittance link corresponds to members of the remittance to be inspected; a second acquisition unit 420, configured to obtain, by the supervising member from the blockchain, a first inspection result of a compliance inspection performed by at least one member in the remittance link on an inspection document that corresponds to the remittance to be inspected; an inspection unit 430, configured to perform, by the supervising member, a compliance inspection on the inspection document to obtain a second inspection result; and a verification unit 440, configured to determine, by the supervising member, a member whose compliance inspection is abnormal based on the second inspection result and the first inspection result.

In an optional implementation, before the first acquisition unit 410, the apparatus further includes the following: a receiving sub-unit, configured to receive, by the supervising member, a remittance inspection request initiated by at least one member in the blockchain.

In an optional implementation, before the first acquisition unit 410, the apparatus further includes the following: a determining sub-unit, configured to determine, by the supervising member, a completed remittance in the blockchain as the remittance to be inspected when registering the completed remittance in a blockchain ledger.

In an optional implementation, the second acquisition unit 420 includes the following: the supervising member initiates a contract operation to the blockchain, where the contract operation is used to obtain, from the blockchain, the first inspection result of the compliance inspection performed by the at least one member in the remittance link on the inspection document that corresponds to the remittance to be inspected.

In an optional implementation, the at least one member is a member that is registered in the blockchain and that the supervising member has a jurisdiction over.

In an optional implementation, the inspection unit 430 includes the following: a pushing sub-unit, configured to push, by the supervising member, the inspection document to a third-party compliance inspection institution, so that the third-party compliance inspection institution implements a compliance inspection; and an obtaining sub-unit, configured to obtain the second inspection result returned by the third-party compliance inspection institution.

In an optional implementation, the verification unit 440 includes the following: a comparison sub-unit, configured to compare, by the supervising member, the second inspection result with a first inspection result of each member; and a determining sub-unit, configured to determine a member whose first inspection result is different from the second inspection result as the member whose compliance inspection is abnormal.

In an optional implementation, the compliance inspection includes at least one of a KYC inspection and an anti-money laundering inspection.

In an optional implementation, the remittance is a cross-border remittance.

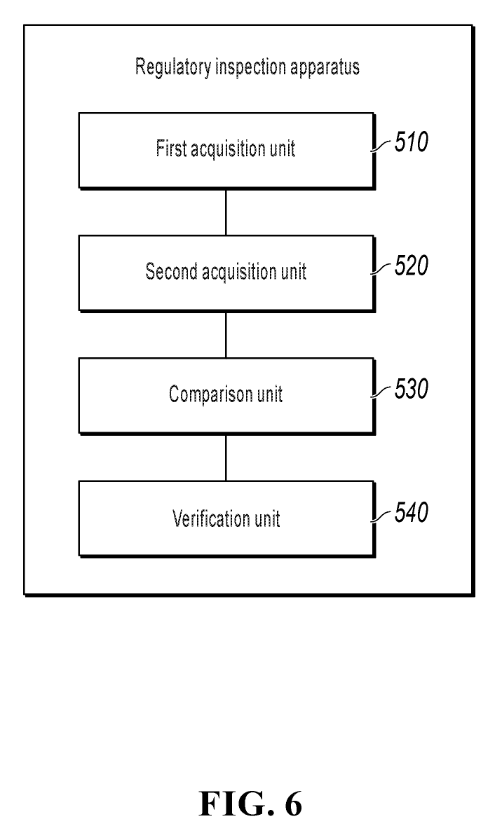

Referring to FIG. 6, FIG. 6 is a diagram illustrating modules of a regulatory inspection apparatus, according to an implementation of the present specification. The apparatus for regulatory inspection can be applied to a remittance system based on a blockchain technology, the apparatus corresponds to the implementation shown in FIG. 4, and the apparatus includes the following: a first acquisition unit 510, configured to obtain, by a supervising member, a remittance link involved in a remittance to be inspected from a blockchain, where the remittance link corresponds to members of the remittance to be inspected; a second acquisition unit 520, configured to obtain, by the supervising member from the blockchain, an inspection result of a compliance inspection performed by at least one member in the remittance link on an inspection document that corresponds to the remittance to be inspected; a comparison unit 530, configured to compare the inspection results of the compliance inspections performed by the relay members on the inspection document; and a verification unit 540, configured to determine a member whose compliance inspection is abnormal based on a comparison result.

In an optional implementation, the member whose compliance inspection is abnormal is a minority of members whose inspection results are different from inspection results of a majority of members.

In an optional implementation, the second acquisition unit 520 includes the following: the supervising member initiates a contract operation to the blockchain, where the contract operation is used to obtain, from the blockchain, the inspection result of the compliance inspection performed by the at least one member in the remittance link on the inspection document that corresponds to the remittance to be inspected.

The system, apparatus, module, or unit illustrated in the previous implementations can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

For an implementation process of functions and roles of each unit in the apparatus, references can be made to an implementation process of corresponding steps in the previous method. Details are omitted here for simplicity.

Because an apparatus implementation basically corresponds to a method implementation, for related parts, references can be made to related descriptions in the method implementation. The previously described apparatus implementation is merely an example. The units described as separate parts may or may not be physically separate, and parts displayed as units may or may not be physical units, may be located in one position, or may be distributed on a plurality of network units. Some or all of the modules can be selected based on actual demands to achieve the objectives of the solutions of the present specification. A person of ordinary skill in the art can understand and implement the implementations of the present application without creative efforts.

FIG. 5 is a schematic diagram illustrating an internal functional module and a structure of a regulatory inspection apparatus. An execution body in essence can be an electronic device, and the electronic device includes the following: a processor; and a memory configured to store an executable instruction of the processor.

The processor is configured to obtain, by a supervising member, a remittance link involved in a remittance to be inspected from a blockchain, where the remittance link corresponds to members of the remittance to be inspected; obtain, by the supervising member from the blockchain, a first inspection result of a compliance inspection performed by at least one member in the remittance link on an inspection document that corresponds to the remittance to be inspected; perform, by the supervising member, a compliance inspection on the inspection document to obtain a second inspection result; and determine, by the supervising member, a member whose compliance inspection is abnormal based on the second inspection result and the first inspection result.

Optionally, before the supervising member obtains the remittance link involved in the remittance to be inspected from the blockchain, the method further includes the following: the supervising member receives a remittance inspection request initiated by at least one member in the blockchain.

Optionally, before the supervising member obtains the remittance link involved in the remittance to be inspected from the blockchain, the method further includes the following: the supervising member determines a completed remittance in the blockchain as the remittance to be inspected when registering the completed remittance in a blockchain ledger.

Optionally, the obtaining, by the supervising member from the blockchain, a first inspection result of a compliance inspection performed by at least one member in the remittance link on an inspection document that corresponds to the remittance to be inspected includes the following: the supervising member initiates a contract operation to the blockchain, where the contract operation is used to obtain, from the blockchain, the first inspection result of the compliance inspection performed by the at least one member in the remittance link on the inspection document that corresponds to the remittance to be inspected.

Optionally, the at least one member is a member that is registered in the blockchain and that the supervising member has a jurisdiction over.

Optionally, the performing, by the supervising member, a compliance inspection on the inspection document to obtain a second inspection result includes the following: the supervising member pushes the inspection document to a third-party compliance inspection institution, so that the third-party compliance inspection institution implements a compliance inspection; and obtains the second inspection result returned by the third-party compliance inspection institution.

The determining, by the supervising member, a relay member whose compliance inspection is incorrect based on the second inspection result and the first inspection result includes the following: the supervising member compares the second inspection result with a first inspection result of each relay member, and determines a relay member whose first inspection result is different from the second inspection result as the relay member whose compliance inspection is incorrect.

Optionally, the compliance inspection includes at least one of a KYC inspection and an anti-money laundering inspection.

Optionally, the remittance is a cross-border remittance.

FIG. 6 is a schematic diagram illustrating an internal functional module and a structure of a regulatory inspection apparatus. An execution body in essence can be an electronic device, and the electronic device includes the following: a processor; and a memory configured to store an executable instruction of the processor.

The processor is configured to obtain, by a supervising member, a remittance link involved in a remittance to be inspected from a blockchain, where the remittance link corresponds to members of the remittance to be inspected; obtain, by the supervising member from the blockchain, an inspection result of a compliance inspection performed by at least one member in the remittance link on an inspection document that corresponds to the remittance to be inspected; compare the inspection results of the compliance inspections performed by the relay members on the inspection document; and determine a member whose compliance inspection is abnormal based on a comparison result.

Optionally, the member whose compliance inspection is abnormal is a minority of members whose inspection results are different from inspection results of a majority of members.

Optionally, the obtaining, by the supervising member from the blockchain, an inspection result of a compliance inspection performed by at least one member in the remittance link on an inspection document that corresponds to the remittance to be inspected includes the following: the supervising member initiates a contract operation to the blockchain, where the contract operation is used to obtain, from the blockchain, the inspection result of the compliance inspection performed by the at least one member in the remittance link on the inspection document that corresponds to the remittance to be inspected.

In the previous implementation of the electronic device, it should be understood that the processor can be a central processing unit (CPU), or can be another general-purpose processor, a digital signal processor (DSP), an application-specific integrated circuit (ASIC), etc. The general-purpose processor can be a microprocessor or the processor can be any conventional processor, and the memory can be a read-only memory (ROM), a random access memory (RAM), a flash memory, a hard disk, or a solid state disk. The steps of the method disclosed with reference to the implementations of the present invention can be directly performed by a hardware processor, or can be performed by using a combination of hardware in the processor and a software module.

The implementations in the present specification are described in a progressive way. For the same or similar parts in the implementations, references can be made to the implementations. Each implementation focuses on a difference from other implementations. Particularly, an electronic device implementation is basically similar to a method implementation, and therefore, is described briefly. For related parts, references can be made to related descriptions in the method implementation.

A person skilled in the art can easily figure out another implementation of the present specification after thinking over the specification and practicing the present disclosure here. The present specification is intended to cover any variations, uses, or adaptations of the present specification, and these variations, uses, or adaptations follow the general principles of the present specification and include common knowledge or conventional techniques that are not disclosed in the technical field of the present specification. The specification and the implementations are merely considered as examples, and the actual scope and the spirit of the present specification are pointed out by the following claims.

It should be understood that the present specification is not limited to the precise structures that have been described above and shown in the drawings, and various modifications and changes can be made without departing from the scope of the present disclosure. The scope of the present specification is limited by the appended claims only.

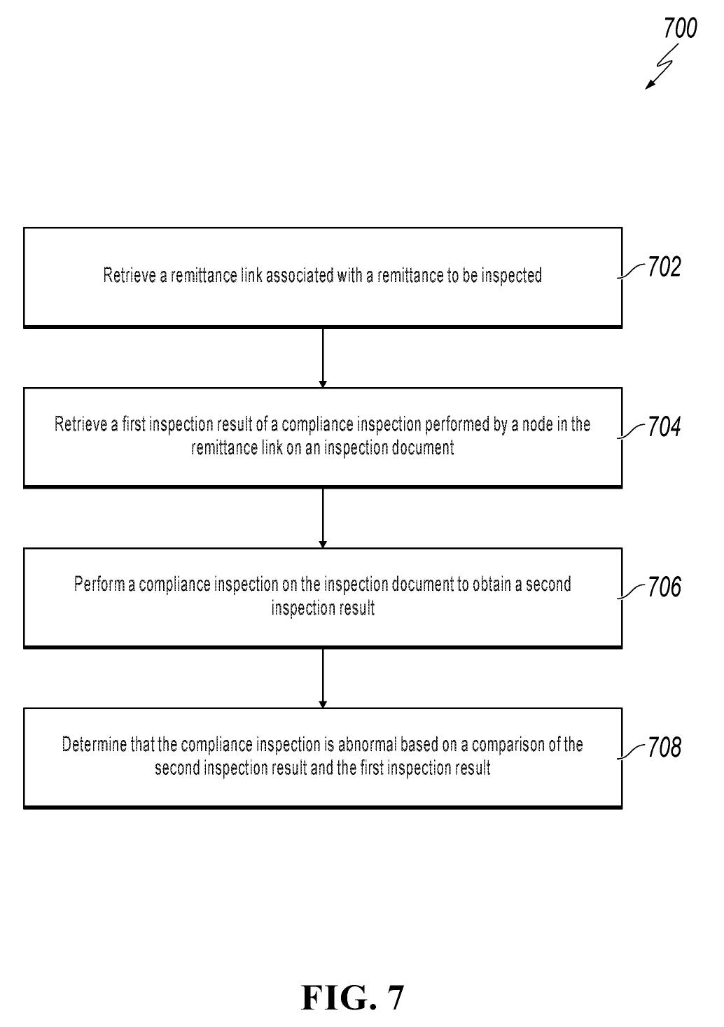

FIG. 7 is a flowchart illustrating an example of a computer-implemented method 700 for regulatory inspection, according to an implementation of the present disclosure. For clarity of presentation, the description that follows generally describes method 700 in the context of the other figures in this description. However, it will be understood that method 700 can be performed, for example, by any system, environment, software, and hardware, or a combination of systems, environments, software, and hardware, as appropriate. In some implementations, various steps of method 700 can be run in parallel, in combination, in loops, or in any order.

At 702, a supervising node in a blockchain network retrieves a remittance link associated with a remittance to be inspected from a blockchain maintained by the blockchain network, wherein the remittance link corresponds to nodes of the remittance to be inspected. In some implementations, the remittance is a cross-border remittance. In some cases, before retrieving the remittance link, the supervising node receives a remittance inspection request from a node in the blockchain network, wherein the supervising node retrieves the remittance link in response to receiving the remittance inspection request. In some cases, before retrieving the remittance link, the supervising node identifies a completed remittance in the blockchain as the remittance to be inspected when the completed remittance is stored in the blockchain. In some implementations, the node is participating in the blockchain network and the supervising node has a jurisdiction over the node.

At 704, the supervising node retrieves from the blockchain a first inspection result of a compliance inspection performed by a node in the remittance link on an inspection document that corresponds to the remittance to be inspected. In some implementations, retrieving the first inspection result comprises initiating a contract operation associated with a smart contract stored in the blockchain, wherein the contract operation is used to obtain, from the blockchain, the first inspection result of the compliance inspection performed by the node in the remittance link on the inspection document that corresponds to the remittance to be inspected.

At 706, the supervising node performs a compliance inspection on the inspection document to obtain a second inspection result. In some cases, performing the compliance inspection comprises pushing the inspection document to a third-party compliance inspection institution to implement a compliance inspection; and retrieving the second inspection result returned by the third-party compliance inspection institution. In some implementations, the compliance inspection comprises at least one of a know-your-customer (KYC) inspection or an anti-money laundering inspection.

At 708, the supervising node determines that the compliance inspection is abnormal based on a comparison of the second inspection result and the first inspection result.

In some implementations, the method 700 includes retrieving, by the supervising node from the blockchain, one or more additional inspection results of compliance inspections performed by a plurality of nodes in the remittance link on an inspection document that corresponds to the remittance to be inspected; comparing the inspection results of the compliance inspections performed by the nodes on the inspection document, the inspection results comprising the first inspection result and the one or more additional inspection results; and determining a node whose compliance inspection is abnormal based on a comparison result. In some cases, the compliance inspection is abnormal if the inspection results are different from inspection results of a majority of nodes in the blockchain network. In some implementations, the blockchain includes a mapping relationship between the plurality of nodes in the remittance link.

The techniques described in this specification provide various technical effects. For example, the techniques enable a computing system to detect abnormal inspection behavior by a node in the blockchain network, which provides a greater level of security in the blockchain network. In addition, the techniques herein enable a computing system to analyze inspection results produced by multiple nodes in the blockchain network and determine which of the nodes provided a correct inspection result and which did not based on the inspection behavior of a majority of the nodes in the blockchain network.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A method for regulatory inspection, the method comprising:
retrieving, by a supervising node in a blockchain network, a remittance link associated with a remittance to be inspected from a blockchain maintained by the blockchain network, wherein the remittance link corresponds to nodes of the remittance to be inspected;
retrieving, by the supervising node from the blockchain, a first inspection result of a compliance inspection performed by a node in the remittance link on an inspection document that corresponds to the remittance to be inspected;
performing, by the supervising node, a compliance inspection on the inspection document to obtain a second inspection result; and
determining, by the supervising node, that the compliance inspection is abnormal based on a comparison of the second inspection result and the first inspection result.

2. The method of claim 1, wherein before retrieving the remittance link, the method further comprises:
receiving, by the supervising node, a remittance inspection request from a node in the blockchain network, wherein the supervising node retrieves the remittance link in response to receiving the remittance inspection request.

3. The method of claim 1, wherein before retrieving the remittance link, the method further comprises:
identifying, by the supervising node, a completed remittance in the blockchain as the remittance to be inspected when the completed remittance is stored in the blockchain.

4. The method of claim 1, wherein retrieving the first inspection result comprises:
initiating, by the supervising node, a contract operation associated with a smart contract stored in the blockchain, wherein the contract operation is used to obtain, from the blockchain, the first inspection result of the compliance inspection performed by the node in the remittance link on the inspection document that corresponds to the remittance to be inspected.

5. The method of claim 1, wherein the node is participating in the blockchain network and the supervising node has a jurisdiction over the node.

6. The method of claim 1, wherein performing the compliance inspection comprises:
pushing, by the supervising node, the inspection document to a third-party compliance inspection institution to implement a compliance inspection; and
retrieving the second inspection result returned by the third-party compliance inspection institution.

7. The method of claim 1, wherein determining, by the supervising node, the node whose compliance inspection is abnormal comprises:
comparing, by the supervising node, the second inspection result with a first inspection result of each node; and
determining the node whose first inspection result is different from the second inspection result as the node whose compliance inspection is abnormal.

8. The method of claim 1, wherein the compliance inspection comprises at least one of a know-your-customer (KYC) inspection or an anti-money laundering inspection.

9. The method of claim 1, wherein the remittance is a cross-border remittance.

10. The method of claim 1, further comprising:
retrieving, by the supervising node from the blockchain, one or more additional inspection results of compliance inspections performed by a plurality of nodes in the remittance link on an inspection document that corresponds to the remittance to be inspected;
comparing the inspection results of the compliance inspections performed by the nodes on the inspection document, the inspection results comprising the first inspection result and the one or more additional inspection results; and
determining a node whose compliance inspection is abnormal based on a comparison result.

11. The method of claim 10, wherein the compliance inspection is abnormal if it is different from inspection results of a majority of nodes in the blockchain network.

12. The method of claim 10, wherein the blockchain comprises a mapping relationship between the plurality of nodes in the remittance link.

13. A non-transitory, computer-readable medium storing one or more instructions executable by a computer system to perform operations comprising:
retrieving, by a supervising node in a blockchain network, a remittance link associated with a remittance to be inspected from a blockchain maintained by the blockchain network, wherein the remittance link corresponds to nodes of the remittance to be inspected;
retrieving, by the supervising node from the blockchain, a first inspection result of a compliance inspection performed by a node in the remittance link on an inspection document that corresponds to the remittance to be inspected;
performing, by the supervising node, a compliance inspection on the inspection document to obtain a second inspection result; and
determining, by the supervising node, that the compliance inspection of the node is abnormal based on a comparison of the second inspection result and the first inspection result.

14. The computer-readable medium of claim 13, wherein before retrieving the remittance link, the operations further comprise:
receiving, by the supervising node, a remittance inspection request from a node in the blockchain network, wherein the supervising node retrieves the remittance link in response to receiving the remittance inspection request.

15. The computer-readable medium of claim 13, wherein before retrieving the remittance link, the operations further comprise:
identifying, by the supervising node, a completed remittance in the blockchain as the remittance to be inspected when the completed remittance is stored in the blockchain.

16. The computer-readable medium of claim 13, wherein retrieving the first inspection result comprises:
initiating, by the supervising node, a contract operation associated with a smart contract stored in the blockchain, wherein the contract operation is used to obtain, from the blockchain, the first inspection result of the compliance inspection performed by the node in the remittance link on the inspection document that corresponds to the remittance to be inspected.

17. The computer-readable medium of claim 13, wherein the node is participating in the blockchain network and the supervising node has a jurisdiction over the node.

18. The computer-readable medium of claim 13, wherein performing the compliance inspection comprises:
pushing, by the supervising node, the inspection document to a third-party compliance inspection institution to implement a compliance inspection; and
retrieving the second inspection result returned by the third-party compliance inspection institution.

19. The computer-readable medium of claim 13, wherein determining, by the supervising node, the node whose compliance inspection is abnormal comprises:
comparing, by the supervising node, the second inspection result with a first inspection result of each node; and
determining the node whose first inspection result is different from the second inspection result as the node whose compliance inspection is abnormal.

20. A system, comprising:
one or more computers; and
one or more computer-readable memories coupled to the one or more computers and having instructions stored thereon which are executable by the one or more computers to:
retrieving, by a supervising node in a blockchain network, a remittance link associated with a remittance to be inspected from a blockchain maintained by the blockchain network, wherein the remittance link corresponds to nodes of the remittance to be inspected;
retrieving, by the supervising node from the blockchain, a first inspection result of a compliance inspection performed by a node in the remittance link on an inspection document that corresponds to the remittance to be inspected;
performing, by the supervising node, a compliance inspection on the inspection document to obtain a second inspection result; and
determining, by the supervising node, that the compliance inspection of the node is abnormal based on a comparison of the second inspection result and the first inspection result.
